(19) United States
(12) Patent Application Publication
(10) Pub. No.: US 2005/0037214 A1
(43) Pub. Date: Feb. 17, 2005

(54) Nylon composite articles of manufacture and processes for their preparation

(76) Inventor: Robert B. Fish JR., Parkersburg, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/890,769

(22) Filed: Jul. 14, 2004

Related U.S. Application Data
(60) Provisional application No. 60/488,059, filed on Jul. 17, 2003.

(51) Int. Cl. B32B 15/08

(52) U.S. Cl. 428/458; 428/474.4; 428/475.5; 427/402

(57) ABSTRACT

Shaped articles having polyamide and metal layers are disclosed having improved barrier resistant properties. These are suitably bonded by a carboxyl-substituted polyolefin that acts to chemically secure the polyamide and metal layers together. Methods for the preparation of these articles and their use in a variety of applications are also disclosed.

### CROSS REFERENCE TO RELATED APPLICATIONS

This application claims the benefit of U.S. Provisional Application No. 60/488,059, filed Jul. 17, 2003.

### FIELD OF THE INVENTION

The present invention relates to polyamide articles having improved barrier resistant properties. More particularly, the present invention relates to such articles having polyamide and aluminum layers suitably bonded together, and methods for their preparation, for use in a variety of applications including fuel lines, gas tanks, gas cans, motor housings, and heat exchangers.

### BACKGROUND OF THE INVENTION

It is well known that toughening agents such as grafted rubbers or ionic polymers can be employed to improve the toughness of polyamides. See, for example, U.S. Pat. No. 4,174,358 and U.S. Pat. No. 3,845,163. Toughened polyamides can be formed into many useful forms, by, for example, injection molding or extrusion, including coextrusion. Because polyamides have low permeability to gasoline, they are frequently used to form components of gasoline fuel systems. Examples of such components are fuel tanks, fuel hoses, and gas rails.

Nonetheless, as environmental control regulations become more stringent, further reducing the permeability of polyamide articles to gasoline fuel components is an objective of many manufacturers.

There are a multitude of applications requiring hoses and tubing for the transport of fluids. Depending on the nature of the application of interest, such hoses must be sufficiently flexible to define a fluid passage having a particular geometry or design, and to withstand vibration when in use. Moreover many applications not only require the hose to be flexible, but also to offer outstanding barrier performance and low permeability. For example, among the highest demands for low permeability are fuel lines (e.g., containment of volatiles) and refrigeration hose applications (e.g., retention of refrigerant and resistance to water vapor, moisture and air).

Likewise there are a multitude of applications requiring articles for containing fluids. Depending on the nature of these applications, articles would need to be able to be fabricated easily, retain the appropriate fluid or gas, and stand up during conditions of use. This latter requirement would include the possibility that the article might be dropped or accidentally struck.

Layered constructions of different materials have been the subject of previous research, in an effort to combine the best properties of each material to achieve these objectives. For example, it has been recognized that metal layers will provide impermeability to polymeric tubes. Likewise polymeric layers have desirable properties of flexibility and ease of molding (for example, injection molding). However, from a practical perspective combined metal and plastic structures are difficult to manufacture. This is because the materials are so dissimilar that they do not naturally adhere to each other. As a consequence, there remains an active interest in developing approaches to securing metal and plastic together in hose assemblies so that the structures do not fail in use.

By way of example, “sputtering” has been often suggested as a useful technique for applying metal after assembling a structure. However while it may give a complete coating, this technique is widely understood as not providing an appreciable degree of impermeability. Still other attempts to secure metal foil layers to polymeric tubing include wrapping a layer of foil around a preformed tube, either longitudinally or helically. The foil can be lapped and folded over at the seam to provide a complete seal (as described for example in EP A 0 024 220 and U.S. Pat. No. 4,370,186) or can be welded for example by means of a laser (as described in U.S. Pat. No. 5,991,485). Usually, the foil is overcoated with additional layer(s) of plastic. Tubing made using these processes is costly, as the processes suffer from relatively low productivity. Finally, other techniques employ mesh or helical metal layers which overlay a polymeric layer; while the resulting structures are largely flexible, the intermittent nature of the metal layer compromises the impermeability associated with them.

The barrier properties of metals to gaseous and liquid diffusion is well-known but their use in such articles is difficult to achieve until now. The problem with making articles that include layers of polyamide and aluminum or other metals is that they have poor adhesion. So, in use, it would be expected that the nylon and metal would delaminate, especially as volatile materials built up at the nylon/metal interface. This would rapidly cause a failure of the structure and, therefore, the article.

It is an object of the present invention to provide a wide variety of articles of manufacture including hose and tube constructions, incorporating both metal and plastic and which are at the same time flexible and impervious to fluids that flow therethrough. A further object of the invention is to provide such articles and constructions offering improved resistance to carbon dioxide emissions. It is a feature of the present invention to provide methods for preparation of these composite polymeric and metal structures, in which the polymer is uniquely secured to the metal. Another feature of the invention is that the layers of polymer and metal may be assembled in a variety of configurations. The structures of the invention and the processes for their formation have several advantages associated therewith, among them relative ease of manufacture (and with an attendant reduction in cost) and their suitability in heat exchanger applications and in automotive applications. These and other objects, features and advantages of the invention as disclosed and claimed herein will become apparent upon having reference to the following description of the invention.

### SUMMARY OF THE INVENTION

There is disclosed and claimed herein a shaped article exhibiting improved barrier resistance comprising:
(a) a layer of one or more polyamides or copolymers or blends thereof;
(b) a layer of metal; and
(c) a layer of a carboxyl-substituted polyolefin positioned therebetween to chemically secure said layer of one or more polyamides or copolymers or blends thereof to said layer of metal.

Such articles may further comprise a number of additional layers of polyamide or metal, each secured to one another by the layer of carboxyl-substituted polyolefin. Moreover these layers are moldable into desired shapes (for example, as sheeting for fuel tanks or as hoses or tubing for heat exchanger assemblies).

Another example of use of these materials in a molding application, is to cover a molded part with a shaped or stretched and coated aluminum foil and then overmolding the part.

There is also disclosed and claimed herein a process for the preparation of such shaped articles exhibiting improved barrier resistance. The process comprises forming a layer of one or more polyamides or copolymers or blends thereof and a layer of metal, and adding thereto a carboxyl-substituted polyolefin and applying heat suitable for chemically securing said layer of one or more polyamides or copolymers or blends thereof to said layer of metal.

The invention will become better understood upon having reference to the description that follows and in conjunction with the drawings herein.

### BRIEF DESCRIPTION OF THE DRAWINGS

FIG. 1 is a perspective view of a tube construction of one embodiment of the invention; and

FIG. 2 is a cross sectional view of a construction of another embodiment of the invention.

### DETAILED DESCRIPTION OF THE INVENTION

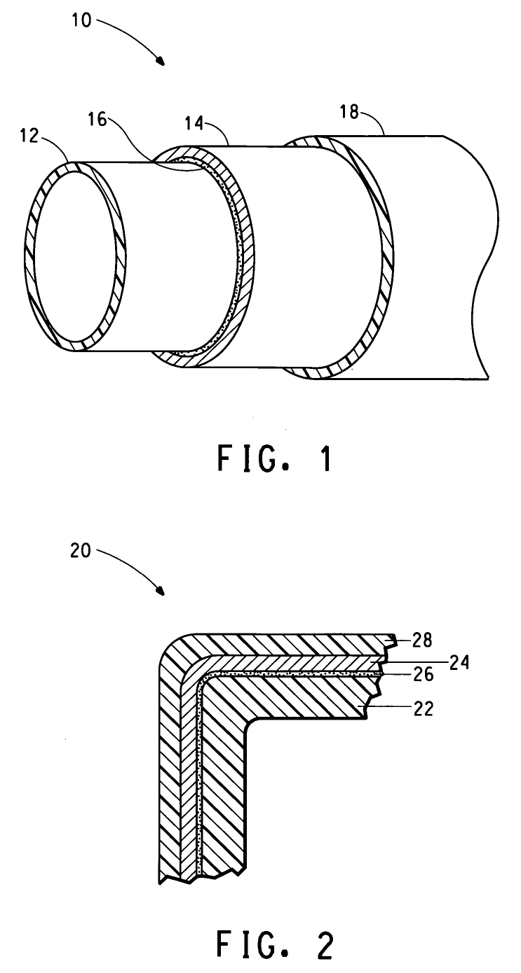

Having reference to FIG. 1 herein, the composite construction of one embodiment of the present invention is depicted generally at 10. In this structure one or more polymeric tubes 12 are provided. Positioned adjacent to the polymeric tube 12 is a metal layer 14. Adhesive material 16 is applied to the surface of said metal layer 14 that interfaces with the polymeric tube 12. Such adhesives 16 promote the attachment of the metal layer 14 to the polymeric tube 12. In this embodiment, the adhesive material 16 is applied to both sides of the metal layer 14 and an additional polymeric layer 18 is applied on the outer diameter of the construction. In this embodiment, the polymeric materials could be formed by melt extrusion and the metal surface could be applied by wrapping in a helical fashion.

Another embodiment of the instant invention is depicted in FIG. 2 as a molded article. Having reference to this figure, a molded article is generally shown at 20 and is produced by overmolding. In this structure one or more polymeric layers 22 are provided. Positioned adjacent to the layer 22 is a metal layer 24. Adhesive material 26 is applied to the surface of said metal layer 24 that interfaces with the polymeric layer 22. Such adhesives 26 promote the attachment of the metal layer 24 to the polymeric layer 22. In this embodiment, the adhesive material 26 is applied to both sides of the metal layer 24 and an additional polymeric layer 28 is applied on the outside of the construction. In this embodiment, injection molding could form the polymeric materials and the metal surface could be applied by overmolding.

Tubing and hose requirements for a number of industrial applications include very high barrier to water, or air/oxygen or contained materials such as fuel compositions or refrigerants. For example, when attempting to design an automotive or vehicle application requiring the effective transport of gasoline products through appropriate fuel lines, the tubing selected must meet a number of stringent requirements including low permeability of hydrocarbons there-through and resistance to chemical attack over an extended period of use. Likewise when attempting to design a refrigerant-capable exchanger from polymeric tubing, or otherwise a heat exchanger assembly, the refrigerant or other contained fluid must be retained inside the tubing structure for a long time such as for many years, with minimal losses.

Moreover in both fuel and refrigerant applications, moisture and air must be prevented from permeating into the tubing. Air is non-condensable and would diminish the performance of the overall system. These systems also typically operate under high pressures (several hundred psig) and the tubing must be capable of withstanding 3-5 times the normal system operating pressures. Unfortunately, the best polymeric barrier materials available may at times be insufficient to keep moisture and air entry below an acceptable level. For at least some of the intended applications, i.e. those involving refrigerants under pressure, it is therefore desirable to achieve a fully bonded structure, in order to prevent pockets of pressurized refrigerant from forming between the tubes and the film layers. This requires that as much of the air between the film layers and the tubes as possible be removed during the manufacturing process. This can be accomplished by withdrawing the air using conventional vacuum equipment, or alternatively squeezing the air out using externally applied pressure.

As further shown in FIG. 1 (or 2), the metal-layer 14 (or 24) is positioned around the polymeric layer 12 (or 22) and is bonded thereto by adhesive material 16 (or 26) applied to one or both sides of the metal. It is desirable to produce a tight fitting of the metal layer 14 (or 24) to the polymeric layer 12 (or 22), with no significant free volume between the contact surfaces. Delamination, as gases or volatile liquids permeate to the polymer/metal interface, will occur if the metal is not tightly bonded to the polymer layer 12 (or 22). As best illustrated in FIG. 1, by careful selection of the adhesive material 16 and controlled application of the metal layer 14 to the polymeric layer 12 (here, a tube) using techniques readily appreciated by those of ordinary skill in the art (for example, wrapping of the metal layer 14 under tension as it is applied to the surface of the polymeric tube and maintaining the appropriate melt temperatures and melt pressures) any significant air gaps or voids are minimized.

A number of different polymers could be chosen for the polymeric layer or tube (and individual polymeric layers constituting the polymeric tubular structure may even be dissimilar polymeric materials). The selection of suitable material depends on the needs for specific applications and should be based on factors such as service temperature, chemical resistance and pressure (which is related to tensile strength). It is readily appreciated that multiple polymeric layers may even be used, e.g., it may not be necessary for each polymeric layer to be separated by (and adhesively bonded to) a metal layer. Polyamides are the preferred material for the polymeric tubes and the polymeric layers, and specifically nylon 66, nylon 6, nylon 612, nylon 11, nylon 12, copolymers thereof, and other nylons with similar melting points are most preferred. Copolyamides containing repeat units derived from terephthalic acid and/or isophthalic acid, or having melting points above about 29° C., are also suitable for purposes of the invention.

In selecting a metal suitable for the metal layer, a number of considerations must be taken into account. The degree of stiffness or flexibility required for the hose or tube for the intended application is one factor. Moreover, for more corrosive applications, a more corrosion resistant metal such as nickel or tin may be used as the metal layer.

The adhesive material is compatible with both the material of the polymeric layer and the metal layer. For example, this adhesive material may be applied as a coating as appropriate to the interior or exterior surface of the polymeric tube designated to contact the metal layer, or may be dispersed within or otherwise added to the polymeric tube in sufficient amounts to impart adhesive qualities to such surfaces to promote contact with the metal layer. Additionally and in the preferred embodiment, if may be supplied already coated on the metal.

The adhesive material is a carboxyl-substituted polyolefin, which is a polyolefin that has carboxylic moieties attached thereto, either on the polyolefin backbone itself or on side chains. By ‘carboxylic moiety’ is meant carboxylic groups such as one or more of dicarboxylic, diesters, dicarboxylic monoesters, acid anhydrides, monocarboxylic acids and esters, and salts. Carboxylic salts are neutralized carboxylic acids. A useful subset of the adhesive material is a dicarboxyl-substituted polyolefin, which is a polyolefin that has dicarboxylic moieties attached thereto, either on the polyolefin backbone itself or on side chains. By ‘dicarboxylic moiety’ is meant dicarboxylic groups such as one or more of dicarboxylic acids, diesters, dicarboxylic monoesters, and acid anhydrides.

The carboxyl-substituted polyolefin will preferably be substantially resistant to swelling in the presence of gasoline or other hydrocarbon or alcohol-containing solvents. Examples of suitable carboxyl-substituted polyolefins include polyethylene, high density polyethylene, and polypropylene that contain carboxylic moieties. The carboxylic moiety may be introduced by grafting the polyolefin with an unsaturated compound containing carboxyl moiety, such as a carboxylic acid, ester, dicarboxylic acid, diester, acid ester, or anhydride. A preferred grafting agent is maleic anhydride. The carboxylic moiety may also be introduced by copolymerizing an unsaturated compound containing carboxyl moiety, such as a carboxylic acid, ester, dicarboxylic acid, diester, acid ester, or anhydride with the monomers used to prepare the polyolefin. A preferred comonomer is maleic anhydride.

The carboxyl-substituted polyolefin may also be an ionomer. By an ionomer is meant a carboxyl group containing polymer that has been neutralized or partially neutralized with metal cations such as zinc, sodium, or lithium and the like. Examples of ionomers are described in U.S. Pat. Nos. 3,264,272 and 4,187,358. Examples of suitable carboxyl group containing polymers include, but are not limited to, ethylene/acrylic acid copolymers and ethylene/methacrylic acid copolymers. The carboxyl group containing polymers may also be derived from one or more additional monomer, such as, but not limited to, butyl acrylate. Zinc salts are preferred neutralizing agents. A preferred ionomer is ethylene/methacrylic acid copolymer partially neutralized with zinc ions. Ionomers are commercially available under the Surlyn® trademark from E.I. du Pont de Nemours and Co., Wilmington, Del.

The combination of all of these features results in a relatively simple low cost composite material (structure of one or more polyamide tubes with adhesives and one or more metal layers) which could be produced in a low cost process and which would be fully functional as fuel lines, refrigerator hose, and the like.

While for many applications the tubes described herein can be circular in cross-section, other shapings including elliptical or other non-circular shapes are also contemplated. The tubing may be extruded as elliptical in shape or may be extruded as circular in shape and then made elliptical in the process of manufacture. Tube diameters and wall thicknesses are sized to handle the pressure of respective applications, as will be selected by those of skill in the field.

In making a multi-layer hose, one would first lay down a layer of polyamide followed by wrapping with hose in a helical fashion with an aluminum foil coated on each side with a carboxyl-substituted polyolefin. Application of another layer of polyamide would follow thereafter. It is important that extrusion temperatures be sufficient to melt the carboxyl-substituted polyolefin and allow the grafting reaction between the carboxyl moiety and the nylon amine ends to occur.

It will be readily apparent that any number of variations and modifications to the subject matter disclosed herein can be made, and are contemplated as within the scope and purview of the invention herein.

The articles of the present invention may be in the form of tubes, pipes, fuel lines, fuel tanks, fuel tanks, motor housings, or other applications that require resistance to exposure to hydrocarbon fuels, solvents, and the like.

### EXAMPLES

Preparation of Test Specimens

Zytel® 101 NC010, a nylon 6,6 commercially available from E.I. du Pont de Nemours & Co. Inc., was molded into disks with a 4 inch diameter and 1/8 inch thickness using standard commercial injection molding equipment.

Adhesive films were prepared by pressing approximately 5 g of each adhesive material shown Table 1 in a PHI Manual Compression Press at 180° C. To prevent the samples from adhering to the press, a back of fluoropolymer film was used. Before removing the pressed sample from the press, it was allowed to cool.

Test disks were prepared by stacking, in order, a polyamide disk, adhesive film, aluminum foil, a second sample of the same adhesive film, and a second polyamide disk. This assembly was placed in the press, which had been preheated to 180° C. The assembly was allowed to heat for 2 minutes and then pressed at 10,000 psi for 5 minutes, removed, and allowed to cool.

Test specimens were cut with a band saw into 1-inch squares from the resulting test disks and were used for fuel resistance testing. Remaining portions of the test disks were used for laminate strength testing.

TABLE 1

| | Material | Supplier | Description |
|---|---|---|---|
| Example 1 | Surlyn ® 9520 | DuPont | Ethylene/ |
| | | | methacrylic acid |
| | | | copolymer |
| | | | partially |
| | | | neutralized with |
| | | | zinc ions |
| Example 2 | Bynel ® 50E662 | DuPont | Polypropylene |
| | | | grafted with |
| | | | maleic anhydride |
| Example 3 | Bynel ® 4003 | DuPont | High density |
| | | | polyethylene |
| | | | grafted with |
| | | | maleic anhydride |
| Example 4 | Bynel ® 41E755 | DuPont | High density |
| | | | polyethylene |
| | | | grafted with |
| | | | maleic anhydride |
| Comparative | Surlyn ® | DuPont | Ethylene/butyl |
| Example 1 | EP4934-4 | | acrylate/glycidyl |
| | | | methacrylate |
| | | | copolymer |
| Comparative | Flexomer ® | Dow | Low density |
| Example 2 | 1085 | Chemical | polyethylene |
| | | Corp., | |
| | | Dabury, CT | |
| Comparative | DPE20 | DuPont | Low density |
| Example 3 | | | polyethylene |
| Comparative | Fusabond ® N | DuPont | EPDM elastomer |
| Example 4 | MF521D | | grafted with |
| | | | maleic anhydride |

Fuel Resistance Testing

Each sample was immersed in each of two solvent mixtures that were designed to simulate exposure to gasolines. The solvent mixtures were regularly replaced with fresh solutions. Solvent mixture A consisted of 50 volume percent toluene and 50 volume percent iso-octene. Solvent mixture B consisted of 45 volume percent toluene, 45 volume percent iso-octene, and 10 volume percent ethanol. The samples were periodically examined visually for delamination. The results of the testing are shown in Table 2. The presence of visible delamination is indicated by the term “failed” in Table 2.

Laminate Strength Testing

The strength of the laminate was determined using a compressive shear test. Testing was done as described in U.S. Pat. No. 6,521,347, which is hereby incorporated by reference, in particular from column 4, line 65 to column 5, line 40. Two 1-inch square pieces were tested at 23° C. and the results were averaged and reported in Table 2.

TABLE 2

| | Fuel resistance testing | | |
|---|---|---|---|
| | Solvent mixture | Solvent mixture | Laminate |
| | A | B | strength (psi) |
| Example 1 | No visible | No visible | 2359 |
| | delamination | delamination | |
| | after one month | after one month | |
| Example 2 | No visible | No visible | 347 |
| | delamination | delamination | |
| | after one month | after one month | |
| Example 3 | No visible | No visible | 3127 |
| | delamination | delamination | |
| | after one month | after one month | |
| Example 4 | No visible | No visible | 2465 |
| | delamination | delamination | |
| | after one month | after one month | |
| Comparative | Failed after | Failed after | 853 |
| Example 1 | one day | one day | |
| Comparative | No adhesion | No adhesion | Too low to be |
| Example 2 | occurred during | occurred during | tested |
| | the test disk | the test disk | |
| | preparation | preparation | |
| | step and no | step and no | |
| | fuel resistance | fuel resistance | |
| | testing was | testing was | |
| | done | done | |
| Comparative | No adhesion | No adhesion | Too low to be |
| Example 3 | occurred during | occurred during | tested |
| | the test disk | the test disk | |
| | preparation | preparation | |
| | step and no | step and no | |
| | fuel resistance | fuel resistance | |
| | testing was | testing was | |
| | done | done | |
| Comparative | Failed after | Failed after | 2323 |
| Example 4 | one day | one day | |

1. A shaped article exhibiting improved barrier resistance comprising:
(a) a layer of one or more polyamides or copolymers or blends thereof;
(b) a layer of metal; and
(c) a layer of a carboxyl-substituted polyolefin positioned therebetween to chemically secure said layer of one or more polyamides or copolymers or blends thereof to said layer of metal.

2. The shaped article of claim 1 wherein said layer (a) is selected from the group consisting of nylon 66, nylon 6, nylon 11, nylon 12, nylon 612, and copolymers thereof.

3. The shaped article of claim 1 wherein said layer (c) is selected from the group consisting of carboxyl-substituted polyethylene, carboxyl-substituted high density polyethylene, carboxyl-substituted polypropylene, and ionomers.

4. The shaped article of claim 3 wherein the ionomer is an ethylene/methacrylic acid copolymer partially neutralized with zinc ions.

5. The shaped article of claim 3 wherein the carboxyl-substituted polyethylene, carboxyl-substituted high density polyethylene, carboxyl-substituted polypropylene have been grafted with maleic anhydride.

6. The shaped article of claim 1 wherein said layer (a) is selected from copolyamides containing repeat units derived from terephthalic acid and/or isophthalic acid.

7. The shaped article of claim 1 wherein said layer (a) is selected from copolyamides having melting points above about 290° C.

8. The shaped article of claim 1 wherein said layer (b) is aluminum.

9. The shaped article of claim 1 wherein said layer (c) is a maleic anhydride functionalized polymer.

10. The shaped article of claim 1 formed into tubes used in a heat exchanger assembly.

11. The shaped article of claim 1 formed into a fuel tank.

12. The shaped article of claim 1 formed into a pipe useful for the delivery of hydrocarbons.

13. The shaped article of claim 1 formed into a motor housing.

14. A process for the preparation of shaped articles exhibiting improved barrier resistance comprising:
(a) Forming a layer of one or more polyamides or copolymers or blends thereof and a layer of metal; and
(b) Adding thereto a carboxyl-substituted polyolefin and applying heat suitable for chemically securing said layer of one or more polyamides or copolymers or blends thereof to said layer of metal.

15. The process of claim 14 wherein said carboxyl-substituted polyolefin is added to said layer of one or more polyamides or copolymers or blends thereof prior to securing said layer of metal thereto.

16. The process of claim 14 wherein said carboxyl-substituted polyolefin is selected from the group consisting of carboxyl-substituted polyethylene, carboxyl-substituted high density polyethylene, carboxyl-substituted polypropylene, and ionomers.

17. The process of claim 14 wherein the ionomer is an ethylene/methacrylic acid copolymer partially neutralized with zinc ions.

18. The process of claim 14 wherein said carboxyl-substituted polyolefin is coated onto said layer of metal prior to securing said layer of one or more polyamides or copolymers or blends thereof.
